(19) United States
(12) Patent Application Publication
(10) Pub. No.: US 2026/0105011 A1
(43) Pub. Date: Apr. 16, 2026

(54) SCAN CONVERSION CIRCUIT AND METHOD OF CONVERTING DATA SCAN PATTERN

(71) Applicant: Samsung Electronics Co., Ltd., Suwon-si (KR)

(72) Inventors: Junwon MUN, Suwon-si (KR); Kyoungjoon PARK, Suwon-si (KR); Serhoon LEE, Suwon-si (KR); Hoonsung LEE, Suwon-si (KR)

(73) Assignee: Samsung Electronics Co., Ltd., Suwon-si (KR)

(21) Appl. No.: 19/350,223

(22) Filed: Oct. 6, 2025

(30) Foreign Application Priority Data
Oct. 14, 2024 (KR) 10-2024-0139730
Feb. 7, 2025 (KR) 10-2025-0016171

(51) Int. Cl. G06F 13/16

(52) U.S. Cl. CPC G06F 13/1673; G06F 13/1689

(57) ABSTRACT

A scan conversion circuit and a method of converting a data scan pattern are disclosed. The scan conversion circuit includes a data buffer configured to store input data and generate output data having a scan pattern different from the input data, an address buffer configured to store an address for use in performing an input/output (I/O) operation on the data buffer, and processing circuitry configured to cause the scan conversion circuit to, generate the address using the address buffer, and control a scan pattern conversion of the input data to generate the output data.

### CROSS-REFERENCE TO RELATED APPLICATION

This U.S. non-provisional application is based on and claims the benefit of priority under 35 U.S.C. § 119 to Korean Patent Application Nos. 10-2024-0139730, filed on Oct. 14, 2024, and 10-2025-0016171, filed on Feb. 7, 2025, in the Korean Intellectual Property Office, the disclosures of each of which are incorporated by reference herein in their entireties.

### BACKGROUND

Some example embodiments of the inventive concepts relate to a scan conversion circuit, an apparatus including the scan conversion circuit, a system including the scan conversion circuit, and/or a method of converting a data scan pattern, and more particularly to, a scan conversion circuit including a scan conversion controller, an apparatus including the scan conversion controller, a system including the scan conversion controller, and/or a method of converting a data scan pattern, etc.

With the development of mobile devices, such as smartphones, tablets, laptops, etc., electronic devices that include image sensors within a single device are becoming widely used. An image processing apparatus may include an image signal processor that processes an input image generated from an image sensor. As image resolution increases, image data processing becomes more important. An operation of converting the data scan pattern for data processing may be desired and/or required.

### SUMMARY

One or more example embodiments of the inventive concepts provide a scan conversion circuit capable of converting a data scan pattern with reduced buffer size and reduced latency and/or power, an apparatus including the scan conversion circuit, a system including the scan conversion circuit, and/or a method of converting the data scan pattern.

One or more example embodiments of the inventive concepts provide the scan conversion circuit, the apparatus including the scan conversion circuit, the system including the scan conversion circuit, and/or the method of converting the data scan pattern.

According to at least one example embodiment of the inventive concepts, there is provided a scan conversion circuit includes a data buffer configured to store input data and generate output data having a scan pattern different from the input data, an address buffer configured to store an address for use in performing an input/output (I/O) operation on the data buffer, and processing circuitry configured to cause the scan conversion circuit to, generate the address using the address buffer, and control a scan pattern conversion of the input data to generate the output data.

According to at least one example embodiment of the inventive concepts, there is provided a scan conversion circuit including a data buffer configured to store input data and generate output data having a scan pattern different from the input data, and processing circuitry configured to cause the scan conversion circuit to, calculate an address for use in performing an input/output (I/O) operation on the data buffer by using a lookup table, and control a read operation and a write operation of the data buffer based on the address, perform a raster scan operation on the input data, and convert the raster scanned data into the output data by performing a tile scan operation, or perform a tile scan operation on the input data, and convert the tile scanned data into the output data by performing a raster scan operation, and wherein the calculating the address by using the lookup table further includes calculating the address based on an address count of I/O operations performed on the data buffer in one cycle, a tile width, and a width of the input data.

According to at least one example embodiment of the inventive concepts, there is provided a method of converting a data scan pattern, the method including receiving input data having a first scan pattern, writing initial data of the input data to a data buffer based on an initial address, calculating an address associated with an address buffer, reading read data from the address buffer based on the address associated with the address buffer, and reading output data from the data buffer using the read data as an address for the output data, the output data having a second scan pattern different from the first scan pattern.

### BRIEF DESCRIPTION OF THE DRAWINGS

Some example embodiments of the inventive concepts will be more clearly understood from the following detailed description taken in conjunction with the accompanying drawings in which:

FIG. 1 is a block diagram of a data processing system according to at least one example embodiment;

FIG. 2 is a block diagram of a scan conversion circuit according to at least one example embodiment;

FIGS. 3A and 3B are diagrams each illustrating a scan conversion method according to at least one example embodiment;

FIGS. 4A to 4C are diagrams illustrating raster to tile (R2T) conversion, which is a scan conversion operation for converting a data scan pattern, according to at least one example embodiment of the inventive concepts;

FIG. 5A is a diagram of a scan conversion circuit including a scan conversion controller, a data buffer, and an address buffer, according to at least one example embodiment of the inventive concepts, to illustrate the scan conversion operation;

FIG. 5B is a diagram illustrating address calculation for an address buffer according to at least one example embodiment;

FIG. 6 is a diagram of a scan conversion circuit including a scan conversion controller and a data buffer, according to at least one example embodiment the inventive concepts, to illustrate the scan conversion operation;

FIG. 7 is a flowchart illustrating a method of converting the data scan pattern, according to at least one example embodiment the inventive concepts;

FIG. 8 is a flowchart illustrating a method of converting the data scan pattern, according to at least one example embodiment the inventive concepts; and

FIG. 9 is a diagram illustrating operations S50 and S60 in FIG. 8 according to at least one example embodiment.

### DETAILED DESCRIPTION

Hereinafter, some example embodiments are described with reference to the attached drawings.

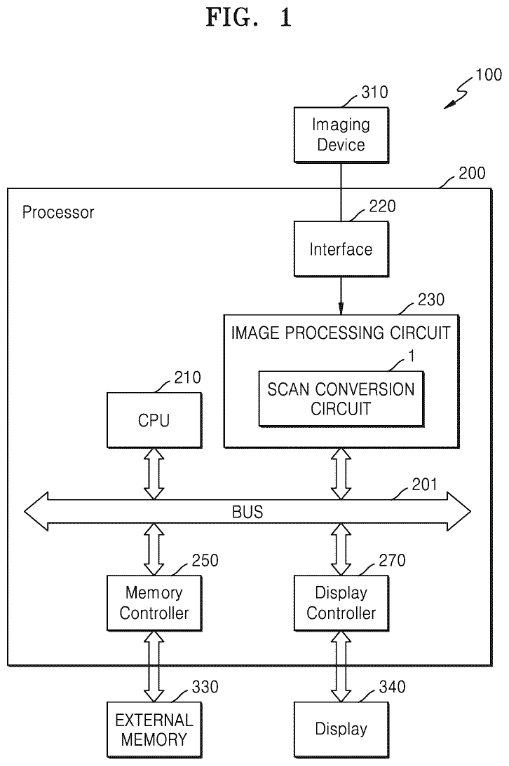

FIG. 1 is a block diagram of a data processing system according to at least one example embodiment.

Referring to FIG. 1, a data processing system 100 may include at least one processor 200, at least one imaging device 310, at least one external memory 330, and/or at least one display 340, etc., but is not limited thereto, and for example the data processing system 100 may include additional components or may omit some components.

The data processing system 100 may be implemented as a personal computer (PC), a server, a smart device, an Internet of Things (IoT) device, and/or a mobile computing device, etc., but is not limited thereto. The mobile computing device may be implemented as a laptop computer, a mobile phone, a smartphone, a tablet, a personal digital assistant (PDA), an enterprise digital assistant (EDA), a digital still camera, a digital video camera, a portable multimedia player (PMP), a personal navigation device or a portable navigation device (PND), a handheld game console, a mobile internet device (MID), a wearable computer, an IoT device, an internet of everything (IoE) device, and/or an e-book, etc. In addition, the data processing system 100 may be installed onto electronic devices, such as drones, advanced drivers assistance systems (ADAS), and/or electronic devices provided as components in vehicles, furniture, manufacturing equipment, doors, and/or various measuring devices, etc. As an example, the data processing system 100 may be implemented as an electronic device which captures an image, displays the captured image, and/or performs an operation based on the captured image, but is not limited thereto.

The processor 200 (e.g., processing circuitry) may be implemented as an integrated circuit (IC), a motherboard, a system-on-chip (SoC), an application processor (AP), and/or a mobile AP, a neural network accelerator, an artificial intelligence accelerator, etc., but the processor 200 is not limited thereto.

The processor 200 (e.g., processing circuitry) may include at least one bus 201, at least one central processing unit (CPU) 210, at least one interface 220, at least one image processing circuit 230, at least one memory controller 250, and/or at least one display controller 270, etc. The CPU 210, the image processing circuit 230, the memory controller 250, and/or the display controller 270 may exchange commands and/or data therebetween through the bus 201. According to some example embodiments, one or more of the CPU 210, the interface 220, the image processing circuit 230, the memory controller 250, and/or the display controller 270, etc., may be implemented as processing circuitry. The processing circuitry may include hardware or hardware circuit including logic circuits; a hardware/software combination such as a processor executing software and/or firmware; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc., but is not limited thereto.

The bus 201 may be implemented as a bus using the advanced microcontroller bus architecture (AMBA) protocol, a bus using the advanced high-performance bus (AHB) protocol, a bus using the advanced peripheral bus (APB) protocol, a bus using the AMBA extensible interconnect (AXI) protocol, or any combinations thereof. However, the bus 201 is not limited thereto.

The CPU 210 may control the overall operation of the processor 200. For example, the CPU 210 may control the interface 220, the image processing circuit 230, the memory controller 250, and/or the display controller 270, etc. The CPU 210 may contain one or more cores.

The interface 220 may receive at least one image output from the imaging device 310 and may transmit the same to the image processing circuit 230. The image may refer to a picture, image data, a video stream, a data stream, and/or frame data, etc.

The imaging device 310 may be implemented as a complementary metal oxide semiconductor (CMOS) image sensor chip and/or a camera module. The imaging device 310 may transmit the image to the interface 220 through the mobile industry processor interface (MIPI)® camera serial interface (CSI), but is not limited thereto. In at least one example embodiment, the data processing system 100 may include multiple imaging devices. For example, when the data processing system 100 includes a dual camera (e.g., two cameras), a first imaging device may be a rear camera and a second imaging device may be a front camera, but the example embodiments are not limited thereto. For example, the resolution of a first image generated from the first imaging device may be different from the resolution of a second image generated from the second imaging device, but is not limited thereto.

The image processing circuit 230 may perform image processing of the image, such as at least one of auto dark level compensation, bad pixel replacement, noise reduction, lens shading compensation, color correction, RGB gamma correction, edge enhancement, hue control, and/or color suppression, etc., but is not limited thereto. In at least one example embodiment, the image processing circuit 230 may be implemented as a multi-core image signal processor (ISP), but is not limited thereto.

The image processing circuit 230 may include a scan conversion circuit 1 (e.g., scan conversion circuitry, etc.) that converts at least one data scan pattern. For example, the scan conversion circuit 1 may convert data of a first scan pattern into data of a second scan pattern. For example, the first scan pattern may include a raster scan pattern and the second scan pattern may include a tile scan pattern, but are not limited thereto. Alternatively, the first scan pattern may include a tile scan pattern and the second scan pattern may include a raster scan pattern, etc.

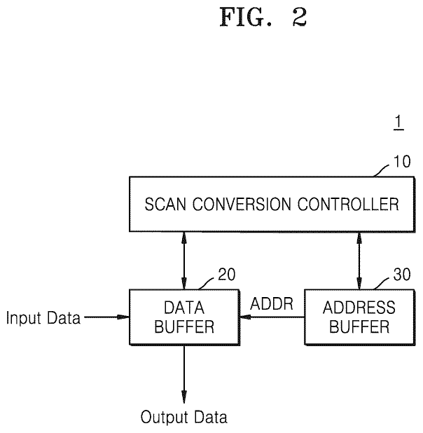

The scan conversion circuit 1 according to at least one example embodiment of the inventive concepts may include a data buffer (e.g., 20 of FIG. 2) that stores input data of the first scan pattern and outputs output data of the second scan pattern, and the scan conversion controller (e.g., 10 of FIG. 2) that calculates an address for use for an input/output (I/O) operation, such as a read operation and/or a write operation on the data buffer, associated with of the data buffer. The address associated with the data buffer calculated by the scan conversion controller 10 may be stored in an address buffer (e.g., 30 of FIG. 2) outside and/or external to the scan conversion controller 10 and/or may be stored in a lookup table buffer inside the scan conversion controller 10. By separately calculating and managing the address of the data buffer 20, the scan conversion controller 10 may reduce the size of the data buffer 20, reduce the latency of the operation of converting the data scan pattern, and/or reduce the power consumption of the operation of converting the data scan pattern, etc.

The image processing circuit 230 may further include at least one ISP. For example, the ISP may perform data processing on the output data output from the scan conversion circuit 1. In at least one example embodiment, the ISP may include, but is not limited to, multiple cores.

For example, the ISP may perform image signal processing to reduce noise on data and improve image quality, such as gamma correction, color filter array interpolation, color matrix, color correction, and/or color enhancement, etc. In addition, the ISP may perform compression on the image data generated by performing image signal processing to generate an image file with a reduced file size and/or may restore uncompressed image data from a compressed image file.

In addition to the image processing operations described above, the ISP may also perform an operation of converting the format of image data into full image data of red color, green color, and blue color, but is not limited thereto.

Although the scan conversion circuit 1 included in the image processing circuit 230 is described with reference to FIG. 1, the scan conversion circuit 1 according to at least one example embodiment of the inventive concepts is not limited thereto. The scan conversion circuit 1, which converts the scan method of data, may be applied to various circuits. For example, the scan conversion circuit 1 may be included in a video processor, a compressor including an image/video codec, multilayer temporal noise reduction (MTNR) intellectual property (IP) that performs tile processing, and/or geometric distortion correction (GDC) IP, etc.

In at least one example embodiment, the scan conversion circuit 1 may be implemented to include a separate controller for video/image scan pattern conversion in a processor, such as a CPU, a graphics processing unit (GPU), and/or a multimedia chip, etc. According to at least one example embodiment, the scan conversion circuit 1 may be applied when tile processing is desired, such as a neural network (NN) and/or local motion (LM), etc. For example, the scan conversion circuit 1 may be used in a hardware accelerator that obtains the computational results of an NN in tile format and performs preprocessing and/or post-processing, etc., but is not limited thereto.

FIG. 2 is a block diagram of a scan conversion circuit according to at least one example embodiment.

Referring to FIG. 2, the scan conversion circuit 1 may include the scan conversion controller 10, the data buffer 20, and/or the address buffer 30, etc. In at least one example embodiment, the image processing circuit 230 in FIG. 1 may include the scan conversion circuit 1 and/or may include the scan conversion controller 10, but is not limited thereto. The scan conversion circuit 1 may convert the scan method of received input data into another scan method to generate output data.

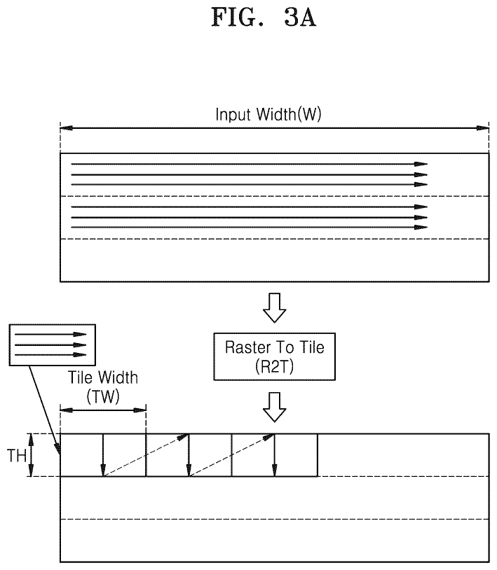

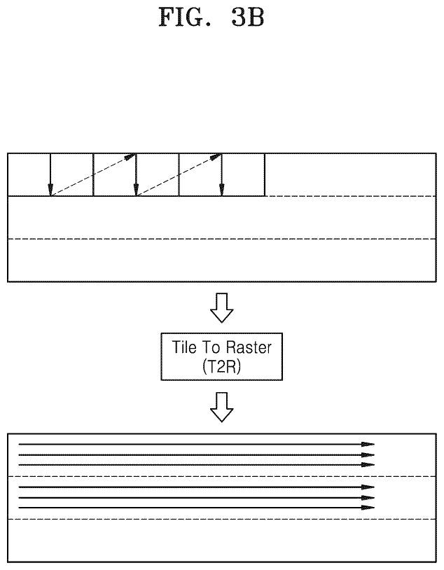

For example, the scan conversion circuit 1 may control the data to be output in a desired scan method regardless of the scan method used to input the image received from the imaging device 310. Alternatively, for example, the scan conversion circuit 1 may control the data to be output in a desired scan method regardless of the scan method to input the data received from the memory controller 250. Some scan methods are described below with reference to FIGS. 3A and 3B.

In at least one example embodiment, the scan conversion circuit 1 may include the data buffer 20 in which input data is stored, and the address buffer 30 in which information about an address to be read/written from/to the data buffer 20 is stored. In at least one example embodiment, the data buffer 20 and the address buffer 30 may include and/or implemented using volatile memory, e.g., static random-access memory (SRAM), etc., but, the example embodiments are not limited thereto. The data buffer 20 and the address buffer 30 may be implemented as various types of buffers. In at least one example embodiment, the address buffer 30 may be implemented as a lookup table and may be used for address calculation of the scan conversion controller 10, but is not limited thereto. The scan conversion controller 10 may perform scan conversion, such as tile to raster (T2R) and/or raster to tile (R2T), etc., using the data buffer 20 and the address buffer 30.

A read operation may be performed on the data buffer 20 to generate output data with a changed scan pattern from the input data. To perform the read operation on the data buffer 20, it is required to calculate the address of the data buffer 20 and the address buffer 30 may be used to calculate the data buffer address. For example, the scan conversion controller 10 may control the address buffer 30 so that an address ADDR for a read operation of the data buffer 20 is output from the address buffer 30. The data buffer 20 may receive the address ADDR from the address buffer 30 and output the output data. According to at least one example embodiment of the inventive concepts, as the scan conversion circuit 1 calculates the address of the data buffer 20 by using the address buffer 30, it may be easier and/or more efficient to calculate the address of the data buffer 20 even though the address of the data buffer 20 has a high complex pattern, and the size of the data buffer 20 may be reduced.

FIGS. 3A and 3B are diagrams each illustrating a scan conversion method according to at least one example embodiment.

A raster scan method may refer to scanning image data sequentially, e.g., scanning the image data line by line. Referring to FIG. 3A, when the total width of the input data is W, the image data may be scanned by sequentially performing the raster scan method by reading first line data as much as the total width W and then reading second line data as much as W, etc. In other words, each row of the image data is read, wherein each row has a width W that equals the total width of the image data, and after each row has been completely read, the next row of the image data is read, etc.

A tile scan method may refer to setting a tile area having a fixed area smaller than the image data and sequentially scanning each line of the image data within the tile area. Referring to FIG. 3A, the width of the set tile area may include a tile width TW, and the height of the tile area may include a tile height TH. Using the tile scan method, image data may be scanned by reading a first line data of the image data as much as TW, which is the width of the tile area, then reading a second line data of the image data as much as TW, and repeating this process up to the line corresponding to TH, which is the height of the tile area. In other words, the image data having a width W may be divided into a plurality of tiles each having a width TW, wherein TW<W, and each tile may be read line by line from a first line (e.g., a top line) to a last line (e.g., a bottom line) of the respective tile, wherein the number of lines in a tile equals TH, and then the next tile is read in the same manner, etc.

FIG. 3A illustrates an example of converting from a raster scan method to a tile scan method according to at least one example embodiment. FIG. 3B illustrates an example of converting from a tile scan method to a raster scan method according to at least one example embodiment. As such, it is shown that the data scan method may be converted depending on the processing method even for the same image data. According to at least one example embodiment, R2T and T2R illustrated in FIG. 3A and FIG. 3B, respectively, may include operations performed by the scan conversion circuit (e.g., 1 of FIG. 1), according to at least one example embodiment of the.

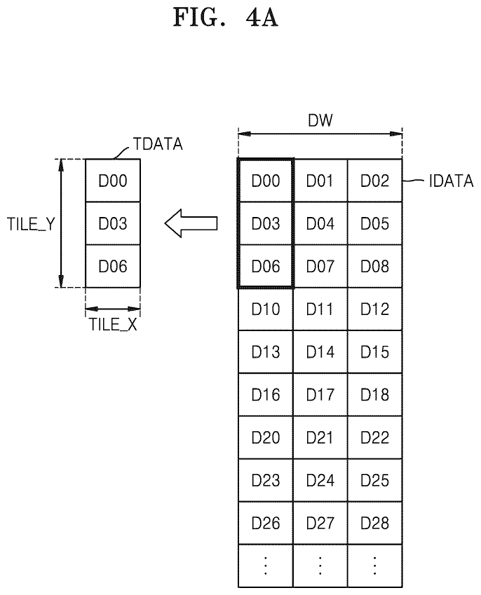

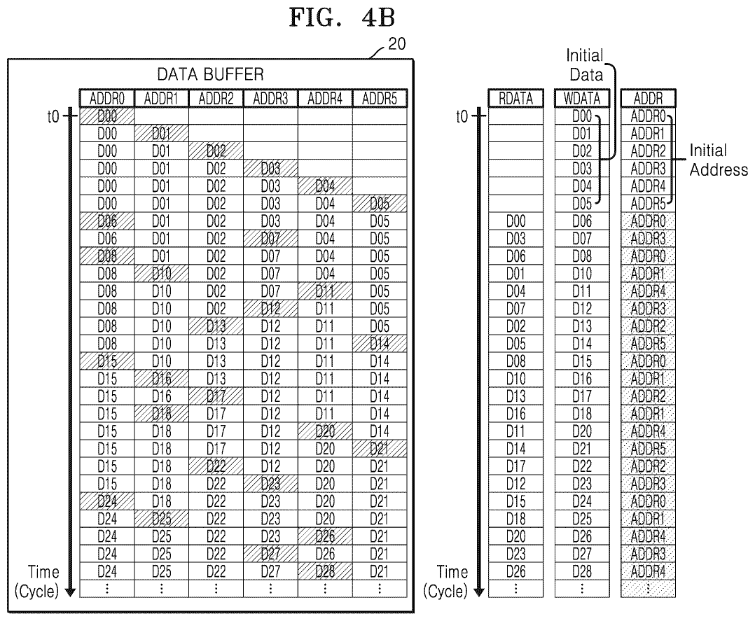

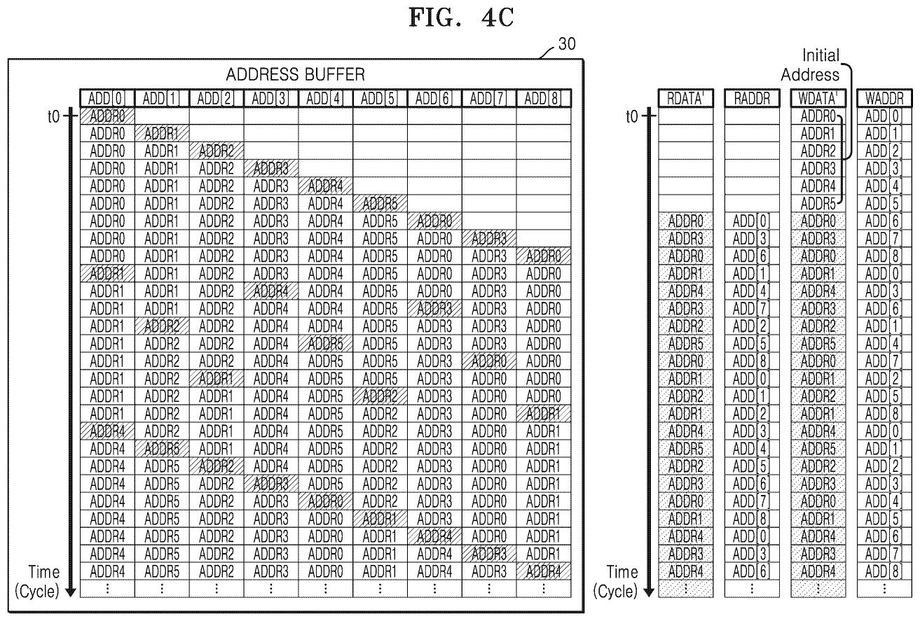

FIGS. 4A to 4C are diagrams illustrating R2T conversion, which is a scan conversion operation for converting a data scan pattern, according to at least one example embodiment of the inventive concepts. The T2R conversion operation may also be similarly applied to the descriptions of FIGS. 4A to 4C. Specifically, FIG. 4A is a diagram illustrating input data IDATA, FIG. 4B is a diagram illustrating read data RDATA, write data WDATA, and address ADDR of the data buffer 20, and FIG. 4C is a diagram illustrating read data RDATA′, a read address RADDR, write data WDATA′, and a write address WADDR of the address buffer 30. The shaded portions between the data buffer 20 of FIG. x and the address buffer 30 of FIG. 4C indicate the points in time when the corresponding data was written to the data buffer 20 or the address buffer 30.

The scan conversion circuit (e.g., 1 in FIG. 2) may output data of the tile scan pattern by segmenting and/or dividing the input data IDATA of the raster scan pattern into units of tile data TDATA. One tile data TDATA may be defined as the size of the tile width TILE_X×the tile height TILE_Y which may correspond to the height of 3 tiles, but the example embodiments are not limited thereto. Therefore, in FIG. 4A, one space of input data IDATA may have a width equal to the tile width TILE_X, and a height defined as “1” for the sake of convenience of description, but the example embodiments are not limited thereto.

Referring to FIGS. 4A to 4C, the input data IDATA, which is a target of the scan conversion operation, may be written to the data buffer 20 as the write data WDATA, and the scan-converted output data may be output from the data buffer 20 as the read data RDATA.

The data buffer 20 may store the input data IDATA, and the address buffer 30 may be used to calculate the address of the data buffer 20, or in other words, data stored in the address buffer 30 may be used to calculate an address in the data buffer 20 for storing the scan-converted output data. For example, the address of the data buffer 20 may have a highly complex pattern due to the size of the address buffer being insufficient to accommodate the data reads and/or data writes being performed as part of the scan conversion operation, but the example embodiments of the inventive concepts may more easily and/or more efficiently calculate the address of the data buffer 20 by using the data stored in the address buffer 30.

FIGS. 4B and 4C show time elapsing in the downward direction with respect to the operations performed in the data buffer 20 of FIG. 4B and the address buffer 30 of FIG. 4C. A single cycle may refer to a period during which the input data IDATA, defined by the tile height TILE_Y of the tile data TDATA and the width DW of the input data IDATA, is written to the data buffer 20. For example, in a first cycle, D00 to D08 of the input data IDATA may be read after being written to the data buffer 20, but the example embodiments are not limited thereto. In a second cycle, D10 to D18 of the input data IDATA may be read after being written to the data buffer 20, etc. In a third cycle, D20 to D28 of the input data IDATA may be read after being written to the data buffer 20, etc.

For example, when the scan conversion operation starts at time t0, as an initial operation, initial data D00, D01, D02, D03, D04, and D05 may be sequentially written to locations indicated by addresses ADDR of the data buffer 20, namely ADDR0, ADDR1, ADDR2, ADDR3, ADDDR4, and ADDR5. At this time, ADDR0, ADDR1, ADDR2, ADDR3, ADDDR4, and ADDR5, which are addresses ADDR of the data buffer 20 where the input data IDATA is stored, may be referred to as initial addresses. The initial addresses of the data buffer 20 may be sequentially written as the write data WDATA′ to the address buffer 30 at the locations indicated by ADD[0], ADD[1], ADD[2], ADD[3], ADD[4], and ADD[5], which are write addresses WADDR of the address buffer 30. The address buffer 30 may sequentially store the write data WDATA′ and write addresses WADDR equal to the tile height TILE_Y−1×1 line (the width DW of the input data IDATA).

Thereafter, the read and/or write operations may be performed on each of the data buffer 20 and the address buffer 30. The input data IDATA may be written as the write data WDATA of the data buffer 20 in the raster scan method, and the address ADDR corresponding to the write data WDATA of the data buffer 20 may be written to the address buffer 30 as write data WDATA′ of the address buffer 30.

The read operation may be performed on the data buffer 20 to generate output data with the changed scan pattern from the input data IDATA. To perform the read operation on the data buffer 20, it is desired and/or required to calculate the address ADDR, and the address buffer 30 may be used to calculate the address ADDR. The address ADDR, excluding the initial address of the data buffer 20, may have a highly complex pattern and thus be complex to calculate, and the address buffer 30 may be used to calculate the address ADDR of the data buffer 20. Therefore, to perform the read operation on the data buffer 20, the read operation on the address buffer 30 may be performed first.

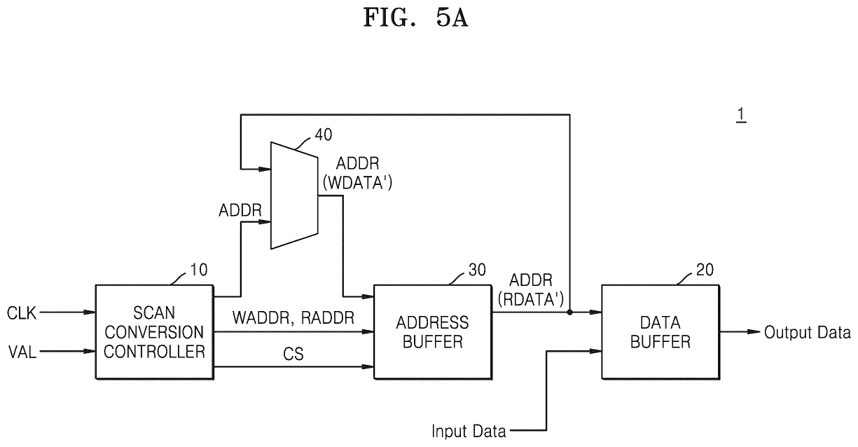

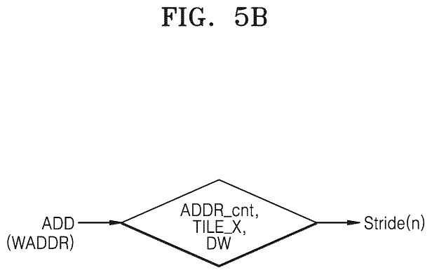

The scan conversion controller (e.g., 10 in FIG. 2) may calculate the read address RADDR of the address buffer 30, wherein the read address RADDR may be calculated based on the buffer size of the data buffer 20, the buffer size of the address buffer 30, the tile width TILE_X, and/or the tile height TILE_Y. The specific method of calculating the read address RADDR of the address buffer 30 is described below with reference to FIG. 5A.

Based on the read address RADDR of the address buffer 30, the read data RDATA′ of the address buffer 30 may be read from the address buffer 30. The read data RDATA′ of the address buffer 30 may also be used as the write data WDATA′ of the address buffer 30. This is because after read data RDATA is read from the data buffer 20, the write data WDATA may be written again to the address corresponding to the read data RDATA. For example, after the image data is read from the data buffer 20, there is a higher probability that the image data will be modified and/or replaced, etc., and written back to the data buffer 20 as the write data WDATA′, etc.

The read data RDATA′ of the address buffer 30 may be used as an address ADDR for reading the data buffer 20, and the read data RDATA of the data buffer 20 may be read from the data buffer 20 by using the read data RDATA′ of the address buffer 30. For example, the read addresses RADDR may be sequentially calculated as ADD[0], ADD[3], ADD[6], ADD[1], ADD[4], ADD[7], ADD[2], ADD[5], and ADD[8], and the read data RDATA′ corresponding to the calculated read addresses RADDR, e.g., ADDR0, ADDR3, ADDR0, ADDR1, ADDR4, ADDR3, ADDR2, ADDR5, and ADDR0, may be sequentially read from the address buffer 30.

The read data RDATA′ of the address buffer 30, e.g., ADDR0, ADDR3, ADDR0, ADDR1, ADDR4, ADDR3, ADDR2, ADDR5, and ADDR0, may be used as the addresses ADDR for reading the data buffer 20. In the data buffer 20, D00, D03, D06, D01, D04, D07, D02, D05, and D08, which are the read data RDATA, corresponding to ADDR0, ADDR3, ADDR0, ADDR1, ADDR4, ADDR3, ADDR2, ADDR5, and ADDR0, respectively, which are the addresses ADDR, may be read sequentially in the first cycle, and the output data of the tile scan pattern may be generated. The operations described above for the first cycle may be performed identically, or substantially the same, for the second and third cycles, etc.

Since the scan conversion circuit 1 according to at least one example embodiment of the inventive concepts operates by using the address buffer 30 to calculate the address ADDR in the data buffer 20, the size of the data buffer 20 may be reduced. In a comparative example where the addresses of the data buffer used in the conversion operation of the data scan pattern are repeated to have a constant pattern (e.g., simple address pattern, regular address pattern, etc.), a line buffer (LB) in the amount of the tile height TILE_Y multiplied by the data buffer 20 may be required. However, in the conversion method of the data scan pattern according to at least one example embodiment of the inventive concepts, the scan conversion operation may be performed even though the LB is in a reduced amount, e.g., the amount of the tile height TILE_Y−1 multiplied by the data buffer 20.

At this time, one LB may be defined according to and/or based on the width DW of the input data IDATA. The size of the data buffer 20 may be less than the size of the LB defined by the width DW and the tile height TILE_Y of the input data IDATA.

For example, as described with reference to FIG. 4B, the scan conversion operation may be performed only with data spaces of TILE_Y−1× LB=2× 3=6 (corresponding to ADDR0 to ADDR5), rather than data spaces of TILE_Y× LB=3× 3=9. In addition, since the size of the data buffer 20 can be reduced, the latency of the scan conversion operation may also be reduced by one reduced line buffer, thereby reducing power consumption, etc.

FIG. 5A is a diagram of a scan conversion circuit including a scan conversion controller, a data buffer, and an address buffer, according to at least one example embodiment of the inventive concepts, to illustrate the scan conversion operation. FIG. 5B is a diagram illustrating address calculation for the address buffer according to at least one example embodiment.

Signals illustrated in FIG. 5A indicate some signals related to the operations of the scan conversion controller 10, the data buffer 20, and the address buffer 30, but the example embodiments are not limited thereto. In addition, one or more signals for the scan conversion operation may be input/output to/from each of the scan conversion controller 10, the data buffer 20, and/or the address buffer 30, etc.

Referring to FIG. 5A, the scan conversion controller 10 may perform the address calculation by receiving a clock signal CLK and/or a valid signal VAL, but is not limited thereto. The clock signal CLK may include, for example, a clock signal for the internal operation of the image processing circuit 230 of FIG. 1, but is not limited thereto. When the clock signal CLK is logic high, the scan conversion controller 10 may output the address ADDR. When the address ADDR is an address for the data buffer 20, the data buffer 20 may write the input data to the corresponding location according to and/or based on the address ADDR for a write operation and/or may read the output data from the corresponding location for a read operation. The scan conversion controller 10 may calculate the address ADDR for the data buffer 20 by using the address buffer 30.

The scan conversion controller 10 may provide the initial address ADDR to the address buffer 30, and the initial address ADDR may be written to the address buffer 30. In addition, the scan conversion controller 10 may perform the address calculation of the address buffer 30 to generate the write address WADDR and the read address RADDR for the address buffer 30, and the address ADDR of the data buffer 20 may be written as write data at a location corresponding to the write address WADDR generated according to and/or based on the address calculation result.

The scan conversion controller 10 may also transmit a control signal CS to the address buffer 30, for example, a signal instructing the address buffer 30 to enable a read operation or a write operation, and/or a signal indicating whether the data buffer 20 is currently being read or written. The scan conversion controller 10 may generate the write address WADDR and the read address RADDR based on information about input data in the current situation and may control the operation of the address buffer 30.

Specifically, the read address RADDR and the write address WADDR of the address buffer 30 may be calculated according to Equation 1. ADD (t,n) may refer to the read address RADDR or the write address WADDR of the address buffer 30, and for example, may refer to the numbers 0 to 8 in ADD[0] to ADD[8] of FIG. 4C.

The Equation 1 below is an example of R2T conversion, where lines of the tile height TILE_Y of the input data are recalculated periodically. The following description may be similarly applied to T2R conversion, and the algorithm/hardware architecture may be similarly applied thereto.

$$[ Equation 1 ]$$

$$BufferSize = ( \frac{DW}{TILE\_X} * TILE\_Y ) ADD ( t , n ) = \{ \begin{matrix}\begin{matrix}0 & if t = 0 \\ BufferSize - 1 & elif t = BufferSize - 1\end{matrix} \\ {ADD}_{temp} ( t , n ) elif {ADDR}_{temp} ( t , n ) < BufferSize \\ {ADD}_{temp} ( t , n ) - ( BufferSize - 1 ) else\end{matrix} ≪ mth 2 ≫ stride ( n ) = {( \frac{DW}{TILE\_X} )}^{n} \% ( BufferSize - 1 )$$

$${ADD}_{temp} ( t , n ) = ADD ( t - 1 , n ) + stride ( n )$$

$$BufferSize = ( \frac{DW}{TILE\_X} * TILE\_Y ) ADD ( t , n ) = \{ \begin{matrix}\begin{matrix}0 & if t = 0 \\ BufferSize - 1 & elif t = BufferSize - 1\end{matrix} \\ {ADD}_{temp} ( t , n ) elif {ADDR}_{temp} ( t , n ) < BufferSize \\ {ADD}_{temp} ( t , n ) - ( BufferSize - 1 ) else\end{matrix} ≪ mth 2 ≫ stride ( n ) = {( \frac{DW}{TILE\_X} )}^{n} \% ( BufferSize - 1 )$$

$${ADD}_{temp} ( t , n ) = ADD ( t - 1 , n ) + stride ( n )$$

n may refer to a cycle. The initial operation of the address buffer 30 may start with a write operation, and the write operation may start from n=0. Since the write operation on the address buffer 30 starts with the read operation, the write address may start from n=1 for the read operation. In each of the read and write operations, the cycle (n) may be increased by 1 every time the line increases by the tile height TILE_Y.

The read operation may start from TILE_Y−1 lines after the write operation. Thereafter, the address buffer 30 may alternately perform the read and write operations for a specific address (e.g., in the order of write, read, write, read, write . . . ). Even though the read operation is performed with a time difference of TILE_Y−1 lines from the write operation, the write operation may not cause loss of meaningful data.

The buffer size of the address buffer 30 may have a value obtained by multiplying the tile height TILE_Y by the value obtained by dividing the width DW of the input data by the tile width TILE_X. For example, referring to FIG. 4C, the buffer size of the address buffer 30 may be “9 (ADD[0] to ADD[8])”.

The n^{th} stride Stride(n) in the n^{th} cycle may refer to a stride of the read address RADDR or a stride of the write address WADDR of the address buffer 30, and may refer to an interval between the read addresses RADDR or an interval between the write addresses WADDR. The n^{th} stride Stride(n) may be calculated as the remainder when a value obtained by raising the ratio of the width DW of the input data to the tile width TILE_X to the n^{th} power is divided by a value obtained by subtracting 1 from the buffer size. For example, referring to FIG. 4C, the stride of the read address RADDR may have a value of “3” and then a value of “1”. That is, in FIG. 4C, the first stride(stride(1)) may be 3, and the second stride(stride(2)) may be 1.

The temporary address (ADDₜₑₘₚ(t,n)) of the address buffer 30 may be calculated as a value obtained by adding the previous address to the n^{th} stride Stride(n). At this time, t may refer to the number of times the read operation or the write operation is performed within one cycle, and t may be 0 at the start of one cycle and may be increased by 1 each time the read operation or the write operation is performed.

Referring to FIGS. 5A and 5B, the n^{th} stride Stride(n) may be calculated not through Equation 1, but through simplified logic. The scan conversion controller 10 may update the n^{th} stride Stride(n) to the address ADD of the address buffer 30, according to and/or based on the tile width TILE_X, the width DW of the input data, and an address count ADDR_cnt. At this time, the address count ADDR_cnt may include a count that accumulates the number of times the address of the address buffer 30 is written per cycle. When a new cycle starts, the address count ADDR_cnt may start from 0. In at least one example embodiment, the scan conversion controller 10 may count using the address count ADDR_cnt so that the address ADDR corresponding to the tile width TILE_X is written as the write data WDATA′ to the address buffer 30. At that time, n^{th} stride Stride(n) may be determined according to and/or based on the write address WADDR of the address buffer 30.

For example, in the n−1^{th} cycle, when the address count ADDR_cnt is equal to a value obtained by dividing the width DW of the input data by the tile width TILE_X (e.g., the base stride) and the write operation is enabled in the address buffer 30, the address ADD (e.g., write address WADDR) of the address buffer 30 may be updated as the n^{th} stride Stride(n).

Referring to FIG. 4C together, in the initial cycle (e.g., n=0), when the address count ADDR_cnt is equal to the value obtained by dividing the width DW of the input data by the tile width TILE_X (e.g., the base stride=3), the address ADD of the address buffer 30 (e.g., the write address WADDR) may have a value of 3 (ADD[3]). In the next cycle, which is the first cycle (e.g., n=1), the stride may be updated to “3”. In the first cycle (e.g., n=1), when the address count ADDR_cnt is equal to the base stride “3”, the address ADD (e.g., write address WADDR) of the address buffer 30 may have a value of 1 (ADD[1]). In the next cycle, which is the second cycle (e.g., n=2), the stride may be updated to “1”.

Referring again to FIGS. 5A and 5B, the read data RDATA′ read from the address buffer 30 may be provided to the data buffer 20 as the address ADDR of the data buffer 20. The address ADDR output from the address buffer 30 may be input again to the address buffer 30. When the read data RDATA′ is read from the address buffer 30, the write data WDATA′ may be written again to the address area where the read data RDATA′ was stored. Thus, the address may be used again after the read data RDATA′ is read.

The data buffer 20 may perform the write/read operations based on the address ADDR received from the address buffer 30. The data buffer 20 may receive the input data (e.g., in raster format or tile format, etc.) to perform the write operation, and may perform the read operation to output the output data (e.g., in tile format or raster format, etc.) having a different scan pattern from the input data.

Accordingly, the scan conversion controller 10, according to at least one example embodiment of the inventive concepts, may reduce the size of the data buffer 20 where data is stored by using the address buffer 30. For example, the data buffer 20 may be implemented with a size of TILE_Y−1 line buffer, which is the minimum buffer size required for scan pattern conversion. The operational latency may be reduced while maintaining the throughput of the scan conversion controller 10, and power consumption may also be reduced due to the usage of a smaller buffer. Additionally, the scan conversion controller 10 may process multiple pixels in one cycle.

The scan conversion circuit 1 (e.g., processing circuitry, etc.) may further include a selection circuit 40, but is not limited thereto. The selection circuit 40 may receive the address ADDR provided from the scan conversion controller 10 and the address ADDR which is the read data RDATA′ output from the address buffer 30, and may select one of the addresses ADDR and provide the same to the address buffer 30 as the write data WDATA′.

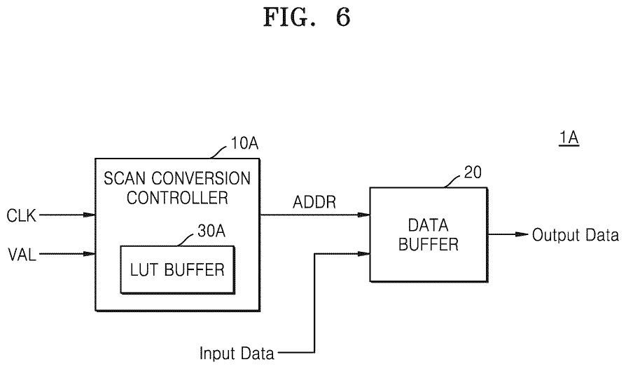

FIG. 6 is a diagram of a scan conversion circuit including a scan conversion controller and a data buffer, according to at least one example embodiment of the inventive concepts, to illustrate the scan conversion operation. Signals illustrated in FIG. 6 indicate some signals related to the operations of the scan conversion controller 10A and the data buffer 20, but the example embodiments are not limited thereto. In addition, signals for the scan conversion operation may be input/output to/from each of the scan conversion controller 10A and the data buffer 20, etc.

Referring to FIG. 6, the scan conversion controller 10A may include a lookup table (LUT) buffer 30A, but is not limited thereto. Like the scan conversion controller 10 using the address buffer 30 of FIG. 5A, the scan conversion controller 10A may perform an operation algorithm (and/or mathematical operation, etc.) of the address ADDR for the data buffer 20 based on the LUT buffer 30A. The scan conversion controller 10A may be used to obtain a highly complex pattern of addresses in the data buffer 20. However, unlike as shown in FIG. 6, the scan conversion controller 10A may also perform an operation algorithm (and/or mathematical operation, etc.) for an address ADDR by using the LUT buffer 30A external to the scan conversion controller 10A. For example, the scan conversion controller 10A may calculate the address ADDR of the data buffer according to and/or based on the address count (e.g., ADDR_cnt of FIG. 5B), the tile width TILE_X of FIG. 5B, and/or the width of input data (DW of FIG. 5B) within one cycle.

In at least one example embodiment, the scan conversion controller 10A may store the result of performing an operation algorithm (and/or arithmetic operation, etc.) of the address ADDR in a configurable register. The operation algorithm performed by the scan conversion controller 10A may be similar to an operation algorithm performed by the scan conversion controller 10 of FIG. 5A. For example, the result of performing the operation algorithm (and/or arithmetic operation, etc.) of the address ADDR may be repeated to have a specific and/or desired pattern, and this pattern may be stored in the configurable register.

The data buffer 20 may receive the address ADDR from the scan conversion controller 10A and may perform the write/read operation based on the address ADDR received from the scan conversion controller 10A. The data buffer 20 of the scan conversion circuit 1A may perform the scan conversion operation even though there are LBs equal to the tile height (e.g., TILE_Y in FIG. 4A-1), but the example embodiments are not limited thereto. That is, the size of the data buffer 20 of the scan conversion circuit 1A may be less than the size of the LB defined by the width of the input data and the tile height.

The data buffer 20 may receive the input data (e.g., in raster format or tile format, etc.) and may perform the write operation. The data buffer 20 may output the output data (e.g., in tile format or raster format, etc.) by performing the read operation, thereby outputting the output data of which the scan pattern is changed from the input data.

Compared to the example of the scan conversion circuit 1 including the address buffer 30 in FIG. 5A, the scan conversion circuit 1A of FIG. 6 may further reduce power consumption since the address ADDR is calculated by the scan conversion controller 10A including the LUT buffer 30A.

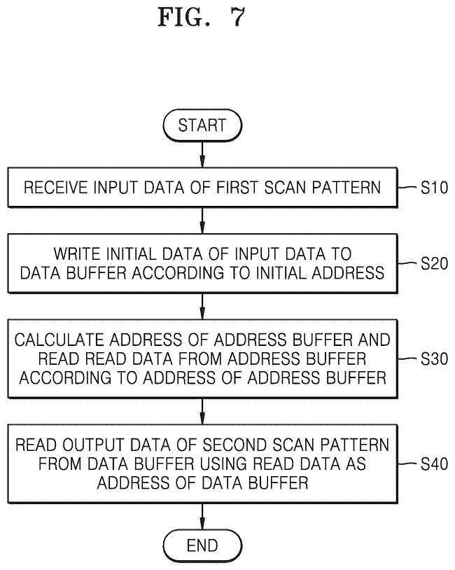

FIG. 7 is a flowchart illustrating a method of converting the data scan pattern, according to at least one example embodiment of the inventive concepts. The method of converting the data scan pattern, described with reference to FIG. 7, may be performed by the scan conversion circuit 1 of FIG. 5A or the scan conversion circuit 1A of FIG. 6, but the example embodiments are not limited thereto.

Referring to FIG. 7, in operation S10, input data of the first scan pattern may be received. For example, the first scan pattern may include a raster scan pattern and/or a tile scan pattern, etc.

In operation S20, initial data among the input data may be written (e.g., stored) in the data buffer according to and/or based on the initial address. The initial address, which is a specified and/or pre-specified address, may be determined based on the size of the data buffer. For example, in FIG. 4B, ADDR0, ADDR1, ADDR2, ADDR3, ADDR4, and ADDR5 may be sequentially determined as initial addresses, and the initial data D00 to D005 may be sequentially written to locations corresponding to the initial addresses ADDR0 to ADDR5, respectively, but the example embodiments are not limited thereto.

In operation S30, the address of the address buffer may be calculated, and the read data may be read from the address buffer according to and/or based on the calculated address of the address buffer. In at least one example embodiment, the address of the address buffer may be calculated using Equation 1 described with reference to FIG. 5A, but is not limited thereto. Alternatively, in at least one example embodiment, the address of the address buffer may have a certain and/or desired pattern with a specific cycle, and the address of the address buffer may be determined by counting the number of read/write operations (e.g., I/O operations) for the address buffer, etc.

In operation S40, the read data output from the address buffer may be used as the address of the data buffer to read (e.g., output) the output data of the second scan pattern from the data buffer. For example, the second scan pattern may include the tile scan pattern or may include the raster scan pattern, etc. Accordingly, the method of converting the data scan pattern according to at least one example embodiment of the inventive concepts may perform the R2T scan conversion operation from the raster scan pattern to the tile scan pattern or may perform the T2R scan conversion operation from the tile scan pattern to the raster scan pattern, etc.

The method of converting the data scan pattern according to at least one example embodiment of the inventive concepts may reduce the size of the data buffer in which input data of the first scan pattern is stored and may output data of the second scan pattern. As the size of the data buffer is reduced, the address for outputting the output data from the data buffer may have a highly complex pattern, and the address buffer may be used to calculate the address of the data buffer. As the size of the reduced data buffer is greater than the size of the address buffer added to calculate the address of the data buffer, the overall size of the scan conversion circuit may be reduced. The address of the address buffer used to calculate the address of the data buffer may be patterned, and the address calculation may be implemented simply and/or more efficiently.

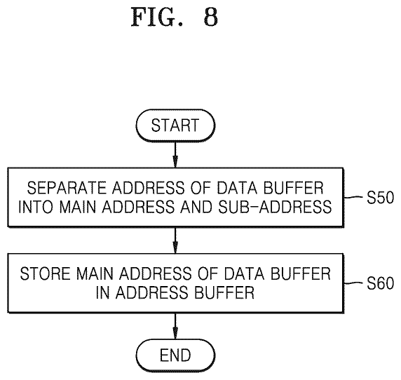

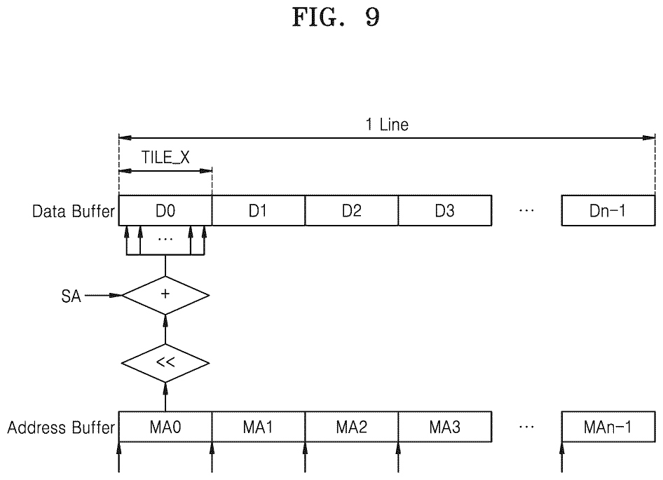

FIG. 8 is a flowchart illustrating a method of converting the data scan pattern, according to at least one example embodiment of the inventive concepts. FIG. 9 is a diagram illustrating operations S50 and S60 in FIG. 8 according to at least one example embodiment. The method of converting the data scan pattern, described with reference to FIG. 8, may be performed by the scan conversion circuit 1 of FIG. 5A or the scan conversion circuit 1A of FIG. 6, but the example embodiments are not limited thereto.

Referring to FIGS. 8 and 9, the method of converting the data scan pattern may divide the address of the data buffer into a plurality of main addresses MA0 to MAn-1 and a sub-address SA in operation S50. In operation S60, the plurality of main addresses MA0 to MAn-1 of the data buffer may be stored in the address buffer.

For example, the plurality of main addresses MA0 to MAn-1 may be determined by an integer part of a value obtained by dividing the width DW of the input data by the tile width TILE_X. For example, the value obtained by dividing the width DW of the data by the tile width TILE_X may be n, and the main addresses MA0 to MAn-1 may be divided into n addresses. Data D0 to Dn-11 of the data buffer defined in units of tile width TILE_X may correspond to the main addresses MA0 to MAn-1, but the example embodiments are not limited thereto.

The sub-address SA may be determined based on the number of write operations (and/or read operations) performed by the data buffer to process the tile width TILE_X. The sub-address SA may correspond to one of the values 0, 1, 2, . . . , N−1. At this time, N may be the number of write operations (and/or read operations) for the data buffer required to process the tile width TILE_X.

The method of converting the data scan pattern according to at least one example embodiment of the inventive concepts may store only the main addresses MA0 to MAn-1 among addresses for the data buffer in the address buffer, and the sub-address SA may be implemented through logic. Accordingly, the size of the address buffer may be reduced. As the tile width TILE_X increases, the size of the address buffer may be reduced and may be implemented to operate using a single buffer and/or a reduced number of buffers.

In at least one example embodiment, the scan conversion controller may control the address buffer to output the main addresses MA0 to MAn-1 stored in the address buffer, and may perform a shift operation on the main addresses MA0 to MAn-1. The scan conversion controller may generate the address of the data buffer by adding the sub-address SA to the shifted data value from the main addresses MA0 to MAn-1.

According to at least one example embodiment of the inventive concepts, there is provided a method including, storing input data to a data buffer, dividing the input data into a plurality of image tiles, each of the plurality of image tiles having a tile width less than a width of the input data, determining an address associated with the data buffer based on data stored in an address buffer, and storing the image tiles into the data buffer based on the determined address.

Some example embodiments provide that the determining the address further includes, performing a read operation on the data buffer prior to the storing the image tiles into the data buffer at a read address stored in the address buffer, and determining the address associated with the data buffer based on the read address.

Some example embodiments provide that the address buffer is a lookup table.

While some example embodiments of the inventive concepts have been particularly shown and described herein, it will be understood that various changes in form and details may be made to the example embodiments without departing from the spirit and scope of the following claims.

What is claimed is:

1. A scan conversion circuit comprising:
a data buffer configured to,
store input data, and
generate output data having a scan pattern different from the input data;
an address buffer configured to store an address for use in performing an input/output (I/O) operation on the data buffer; and
processing circuitry configured to cause the scan conversion circuit to,
generate the address using the address buffer, and
control a scan pattern conversion of the input data to generate the output data.

2. The scan conversion circuit of claim 1, wherein the processing circuitry is further configured to cause the scan conversion circuit to:
generate the address in response to a clock signal and a valid signal.

3. The scan conversion circuit of claim 1, wherein the processing circuitry is further configured to cause the scan conversion circuit to:
output a control signal to the address buffer, the control signal indicating the I/O operation on the data buffer is in progress.

4. The scan conversion circuit of claim 1, wherein the processing circuitry is further configured to cause the scan conversion circuit to:
select one of the generated address and read data output from the address buffer; and
output the selected one as write data to the address buffer.

5. The scan conversion circuit of claim 1, wherein the processing circuitry is further configured to cause the scan conversion circuit to control the scan pattern conversion of the input data by:
performing a raster scan operation on the input data, and
convert the raster scanned data into the output data by performing a tile scan operation on the raster scanned data; or
performing a tile scan operation on the input data, and convert the tile scanned data into the output data by performing a raster scan operation on the tile scanned data.

6. The scan conversion circuit of claim 1, wherein each of the data buffer and the address buffer comprises static random-access memory (SRAM).

7. The scan conversion circuit of claim 1, wherein the processing circuitry is further configured to cause the scan conversion circuit to:
separate the address associated with the data buffer into a main address and a sub-address; and
store the main address in the address buffer.

8. The scan conversion circuit of claim 7, wherein the processing circuitry is further configured to cause the scan conversion circuit to:
calculate the main address by saving an integer part of a value obtained by dividing a data width of the input data by a tile width of the data buffer.

9. The scan conversion circuit of claim 1, wherein the processing circuitry is further configured to cause the scan conversion circuit to:
update a stride of an address of the address buffer within a target cycle based on an address count, a data width of the input data, and a tile width, the address count being a number of times of performing write operations on the address buffer for the target cycle.

10. The scan conversion circuit of claim 1, wherein a size of the data buffer is less than a size of a line buffer, the size of the line buffer corresponding to a tile height and a width of the input data.

11. A scan conversion circuit comprising:
a data buffer configured to,
store input data, and
generate output data having a scan pattern different from the input data; and
processing circuitry configured to cause the scan conversion circuit to,
calculate an address for use in performing an input/output (I/O) operation on the data buffer by using a lookup table, and
control a read operation and a write operation of the data buffer based on the address,
perform a raster scan operation on the input data, and convert the raster scanned data into the output data by performing a tile scan operation, or
perform a tile scan operation on the input data, and convert the tile scanned data into the output data by performing a raster scan operation, and
wherein the calculating the address by using the lookup table further includes calculating the address based on an address count of I/O operations performed on the data buffer in one cycle, a tile width, and a width of the input data.

12. The scan conversion circuit of claim 11, wherein the processing circuitry is further configured to cause the scan conversion circuit to:
calculate the address in response to a clock signal and a valid signal.

13. The scan conversion circuit of claim 11, wherein a size of the data buffer is less than a size of a line buffer, the size of the line buffer corresponding to a tile height and the width of the input data.

14. The scan conversion circuit of claim 11, further comprising:
a configurable register configured to store the address.

15. A method of converting a data scan pattern, the method comprising:
receiving input data having a first scan pattern;
writing initial data of the input data to a data buffer based on an initial address;
calculating an address associated with an address buffer;
reading read data from the address buffer based on the address associated with the address buffer; and
reading output data from the data buffer using the read data as an address for the output data, the output data having a second scan pattern different from the first scan pattern.

16. The method of claim 15, wherein each of the first scan pattern and the second scan pattern is a raster scan pattern or a tile scan pattern.

17. The method of claim 15, further comprising:
writing the read data to the address buffer as write data.

18. The method of claim 15, wherein the calculating the address associated with the address buffer further comprises:
calculating the address associated with the address buffer based on a size of the address buffer, a tile width, and a tile height.

19. The method of claim 15, further comprising:
separating an address associated with the data buffer into a main address and a sub-address; and
storing the main address associated with the data buffer in the address buffer.

20. The method of claim 19, wherein the separating of the address associated with the data buffer into the main address and the sub-address further comprises:
determining the main address based on an integer portion of a result of dividing a width of the input data by a tile width; and
determining the sub-address based on a number of write operations performed on the data buffer to process the input data by the tile width.
